(19) United States
(12) Patent Application Publication
(10) Pub. No.: US 2006/0229209 A1
(43) Pub. Date: Oct. 12, 2006

(54) Copolymers based on n-vinylamide as adjuvants and agents for using in the agrotechnical field

(76) Inventors: Lysander Chrisstoffels, Limburgerhof (DE); Izaskun Manteca Zuazo, Ludwigshafen (DE); Reinhard Stierl, Freinsheim (DE); Rainer Berghaus, Speyer (DE)

Correspondence Address: HUTCHISON LAW GROUP PLLC, PO BOX 31686, RALEIGH, NC, 27612, US

(21) Appl. No.: 10/537,182

(22) PCT Filed: Dec. 1, 2003
(86) PCT No.: PCT/EP03/13513

§ 371 Date: Jun. 1, 2005

(30) Foreign Application Priority Data
Dec. 2, 2002 (DE) 102 56 162.1

(51) Int. Cl. A01N 25/10; C08L 39/04

(52) U.S. Cl. 504/361; 525/205

(57) ABSTRACT

Copolymers based on N-vinylamide as adjuvant and compositions for the agrotechnical field The present invention relates to specific copolymers based on N-vinylamide and to their use as activity-improving adjuvant in the agrotechnical field and in particular in the field of plant protection. Appropriate agrotechnical compositions are likewise described. The copolymers are copolymers of vinylamides and ethylenically unsaturated carboxylic acid esters which are alkoxylated.

The present invention relates to specific copolymers based on N-vinylamide and to their use as activity-improving adjuvant in the agrotechnical field and in particular in the field of plant protection. Appropriate agrotechnical compositions are likewise described.

In addition to the optimization of the properties of the active compound, the development of an effective composition assumes particular importance with a view to industrial production and application of active compounds. An optimum balance between properties, such as biological activity, toxicology, possible effects on the environment and costs, some of which are contradictory, has to be found by proper formulating of the active compound or compounds. In addition, the formulating determines to a large extent the shelf life and the user friendliness of a composition.

Of particular importance to the activity of an agrotechnical composition is the effective uptake of the active compound by the plant. If this uptake takes place via the leaf, this thus shows itself to be a complex transport process, in which the load of active substance, for example a herbicide, must first penetrate the waxy cuticle of the leaf and must subsequently diffuse, via the cuticle, into the underlying tissue to the actual site of action.

It is generally known and is agricultural practice to add specific auxiliaries to formulations for the purpose of improved activity. The amounts of active substance in the formulation can thereby advantageously be reduced while keeping the activity the same, thereby allowing costs to be minimized and, if appropriate, existing statutory regulations to be adhered to. In individual cases, success is achieved in expanding the application spectrum of an active substance in that plants which, without additive, could only be insufficiently treated with a specific active compound are accessible to an appropriate treatment by addition of certain auxiliaries. In addition, the performance under unfavorable environmental conditions can in individual cases be enhanced by a suitable formulation. Consequently, incompatibilities of different active compounds in a formulation can also be avoided.

Such auxiliaries are also occasionally described as adjuvants. They are often surface-active or salt-like compounds. Modifiers, actuators, fertilizers and pH buffers, e.g., can be distinguished, according to method of action. Modifiers affect the wetting, sticking and spreading of a formulation. Actuators break up the waxy cuticle of the plants and improve the penetration of the active compound into the cuticle, both in the short term (in the region of minutes) and long term (in the region of hours). Fertilizers, such as ammonium sulfate, ammonium nitrate or urea, improve the absorption and solubility of the active compound and they can reduce the antagonistic behavior of active compounds. pH buffers are conventionally used for optimum adjustment of the pH of the formulation.

With regard to the uptake of the active compound into the leaf, surface-active substances can act as modifiers and actuators. It is generally accepted that suitable surface-active substances can increase the effective contact area of liquids on leaves through a reduction in the surface tension. In addition, specific surface-active substances can dissolve or break up the waxes of the epicuticle, which makes it easier for the active compound to be absorbed. Furthermore, some surface-active substances can also improve the solubility of active compounds in formulations and thereby avoid or at least delay crystallization. Finally, they can also in certain cases affect the absorption of active compounds by retaining moisture.

Adjuvants of the surface-active type are used in varied ways for agrotechnical applications. They can be subdivided into groups of anionic, cationic, nonionic or amphoteric substances.

Petroleum-based oils are conventionally used as activating adjuvants. In the recent past, seed extracts, natural oils and their derivatives, for example from soybeans, sunflowers and coconut, have also been used.

Synthetic surface-active substances, which are conventionally used as actuators, are inter alia polyoxyethylene condensates with alcohols, alkylphenols or alkylamines which exhibit HLBs ranging from 8 to 13.

The spectrum of homo- or copolymers based on N-vinylamide is varied. In the agrotechnical field, they find application as dispersants (U.S. Pat. No. 5,776,856; DE-A-19917562; EP-A-1099378; EP-A-1097638; WO 99/37285), as binders (DE-A-19843903; DE-A-19843904) or as swelling agents (U.S. Pat. No. 5,904,927) or they are used for the formulating of active compounds which are difficult to dissolve (EP-A-0649649) or for the formation of a coherent solid deposit on the plant (EP-A-0981957). The latter is of importance for the administration of contact insecticides, since this application demands the best possible bioavailability of the insecticide on the leaf.

Additional applications outside the agrotechnical field relate, for example, to use in contact lenses or as adhesive in wound dressings, here again special copolymers based on N-vinyllactam being used which can comprise alkoxylated (meth)acrylates as comonomers (cf. EP-A-0350030 and U.S. Pat. No. 5,407,717).

It is an object of the present invention to make available additional copolymers based on N-vinylamide.

We have found that this object is achieved by the present invention through novel copolymers based on N-vinylamide and their use as adjuvants, and the preparation of agrotechnical compositions comprising these copolymers.

The present invention hence relates to copolymers comprising monomer units
(i) of at least one N-vinylamide,
(ii) of at least one ester of an ethylenically unsaturated carboxylic acid, and, optionally,
(iii) of at least one additional copolymerizable comonomer,
   wherein the carboxylic acid esters exhibit alkoxylate residues of the general formula (I)
   (R¹)ₙ—X—(CHR²CH₂O)_{w}—(CHR³CH₂O)ₓ—(CHR⁴(CH₂)_{y}O)_{z}— (I),
   in which
R¹ is hydrogen or an aliphatic hydrocarbon residue with 3 to 40 carbon atoms, preferably linear or branched, saturated or unsaturated C₃₋₄₀-alkyl;
R², R³, R⁴ are, independently of one another, hydrogen or C₁₋₄-alkyl;
w, x, z correspond, independently of one another, to a value of 0 to 100, the sum of w, x and z being greater than 0;
y corresponds to a value of 1 to 20;
X is N or O,
   n being 1 and R¹ not being hydrogen if X is O; or n being 2 if X is N.

The term “monomer unit” means, in the context of the present disclosure, a monomer which has been incorporated in the polymer, where the monomer which has been incorporated in the polymer, i.e. the monomer unit, in comparison with the actual monomer charged to the polymerization reaction, is not only structurally changed by the polymerization reaction but, in addition, can also exhibit further modifications. Thus, in particular, the monomer units of the carboxylic acid esters can be derived by esterification from the monomers charged to the reaction.

The N-vinylamides include in particular noncyclic representatives, such as N-vinylformamide and N-vinylacetamide, as well as N-vinyllactam. N-Vinyllactams according to the invention are cyclic amides, of which those with 4 to 6 carbon atoms are particularly important. These N-vinyllactams can also exhibit 1, 2 or 3 identical or different alkyl residues with preferably 1 to 4 carbon atoms on the ring. The N-vinyllactams include in particular N-vinylpyrrolidone, N-vinylcaprolactam or the corresponding N-vinyllactams substituted with a methyl or ethyl group.

According to one embodiment, copolymers according to the invention comprise one kind of monomer unit (i), i.e. monomer units of an N-vinylamide. According to an additional embodiment, copolymers according to the invention comprise two or more kinds of monomer units (i), e.g. monomer units of several N-vinylamides, such as N-vinylpyrrolidone and another N-vinylamide chosen from N-vinylcaprolactam, N-vinylformamide and N-vinylacetamide.

According to a preferred embodiment, the monomer units (i) present in the copolymer are composed essentially of monomer units of an N-vinylamide, preferably of N-vinylpyrrolidone.

The copolymers accordingly include in particular monomer units (i) of the formula (VIIa) 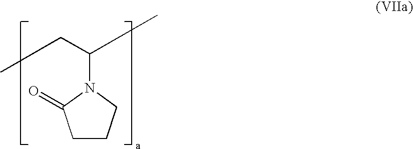
in which a is the mean number of monomer units of the formula (VIIa) in the copolymer and preferably corresponds to a number ranging from 40 to 4 500, advantageously ranging from 65 to 5 000 and in particular ranging from 80 to 3 200.

Esters of ethylenically unsaturated carboxylic acid are suitable as monomer units (ii).

Ethylenically unsaturated carboxylic acid esters with 4 to 8 and in particular 4 to 6 carbon atoms in the carboxylic acid part are preferred in this connection.

Mention may in particular be made of acrylic acid esters and methacrylic acid esters. Among these carboxylic acid esters, methacrylic acid esters are particularly preferred.

The carboxylic acid esters exhibit, as alcohol part, alkoxylates of linear or branched, saturated or unsaturated, primary, secondary or tertiary alcohols or amines. Alcohol alkoxylates are preferred (X═O).

Particular embodiments of alkoxylates of the formula (I) ensue if z corresponds to a value of 1 to 100 and w and x are zero (alkoxylates, such as ethoxylates (R⁴═H; y=1) or propoxylates (R⁴═CH₃; y=1)); if w is zero and x and z correspond, independently of one another, to a value of 1 to 100 (EO/PO block copolymers with, for example, an EO/PO block arrangement (y=1; R³═CH₃; R⁴═H) or a PO/EO block arrangement (y=1; R³═H; R₄═CH₃)); if w, x and z correspond, independently of one another, to a value of from 1 to 100 (EO/PO/EO block copolymers with, for example, an EO/PO/EO block arrangement (y=1; R²═H; R³═CH₃; R⁴═H) or a PO/EO/PO block arrangement (y=1; R²═CH³; R³═H; R⁴═CH³) ).

Alcohol residues of the formula (I) in which R¹ is an alkyl residue with preferably 3 to 30 carbon atoms, in which the longer-chain residues and in particular those with 5 to 15, preferably 8 to 12 and in particular 10 to 12 carbon atoms are advantageous, have proved in particular to be suitable according to the invention.

Alkoxylate residues and in particular ethoxylate residues of the formula (Ia)
R¹—O—(C₂H₄O)_{z}— (Ia)
in which
R¹ has the above meaning and preferably is linear or branched, saturated or unsaturated C₅₋₁₅-alkyl; and
z corresponds to a value of 1 to 100 and preferably lies between 1 and 30,
   are very particularly suitable.

Consequently, R¹ is in particular the following alkyl residues: hexan-1-yl(capryl), heptan-1-yl(oenanthyl), octan-1-yl(caprylyl), nonan-1-yl(pelargonyl), decan-1-yl, undecan-1-yl, dodecan-1-yl(lauryl), tridecan-1-yl, tetradecan-1-yl(myristyl) or pentadecan-1-yl. Mention may also be made, in addition to the abovementioned linear alkyl residues, of branched alkyl residues, such as isodecanyl, isolauryl and isotridecanyl, these branched alkyl residues generally being a mixture of different residues with a corresponding carbon number.

The alkoxylation results from the reaction with suitable alkylene oxides, which generally exhibit 2 to 15 and preferably 2 to 6 carbon atoms. Mention may in particular be made here of ethylene oxide (EO), propylene oxide (PO), butylene oxide (BO), pentylene oxide (PeO) and hexylene oxide (HO).

One type of suitable alkoxylate residues of the formula (I) or (Ia) is based on one kind of alkylene oxide.

Another type of suitable alkoxylate residues of the formula (I) is based on at least two different kinds of alkylene oxide. At the same time, it is preferred to arrange several alkylene oxide units of one kind as a block, so that at least two different alkylene oxide blocks result, which in each case are formed from several units of the same alkylene oxides. If such block alkoxylates are used, it is preferable for the alkylene oxide part to be composed of 3 and in particular of 2 blocks.

According to one aspect, it is preferable for the alkoxylate residues to be used according to the invention to be ethoxylated or at least to exhibit one ethylene oxide block. According to another aspect, ethylene oxide blocks are combined in particular with propylene oxide or pentylene oxide blocks.

The degree of alkoxylation resulting in each case depends on the amounts of alkylene oxide(s) used chosen for the reaction and on the reaction conditions. In this connection, it is generally a statistical mean value since the number of alkylene oxide units of the alcohol alkoxylate residues resulting from the reaction varies.

The degree of alkoxylation, i.e. the mean chain length of the polyether chains of suitable alkoxylate residues according to the invention, can be determined through the molar quantitative proportion of alcohol or amine to alkylene oxide. Alkoxylates with approximately 1 to 50, preferably approximately 1 to 20, in particular 1 to 10 alkylene oxide units (sum of w, x, z), in particular ethylene oxide units, are preferred.

The synthesis of the alcohols or alcohol mixtures which can be used for the alcohol part of the formula (I) or of the amines or amine mixtures which can be used for the amine part of the formula (I) is carried out according to conventional processes known to a person skilled in the art and in equipment conventional for such processes.

The alkoxylation of the alcohols or alcohol mixtures can be catalyzed by strong bases, such as alkali metal hydroxides and alkaline earth metal hydroxides, Brönsted acids or Lewis acids, such as AlCl₃, BF₃, and the like. Catalysts such as hydrotalcite or dimethylcarbonate (DMC) can be used for narrowly distributed alcoholoxylates.

The alkoxylation is preferably carried out at temperatures ranging from approximately 80 to 250° C., preferably approximately 100 to 220° C. The pressure is preferably between ambient pressure and 600 bar. The alkylene oxide can, if desired, comprise an inert gas admixture, e.g. of approximately 5 to 60%.

The alcohols themselves are generally commercially available and can also be prepared in ways known per se. Mention may be made in this connection of the “Guerbet alcohols”, which can be obtained, for example, through dimerization of appropriate primary alcohols at raised temperature in the presence of basic condensation agents; the alcohol mixtures frequently described as “C₁₃-oxo alcohols”, the main component of which is formed from at least one branched C₁₃-alcohol (isotridecanol) and which are generally obtainable by hydrogenation of hydroformylated trimeric butene; and the alcohol mixtures frequently described as “C₁₀-oxo alcohols”, the main component of which is formed from at least one branched C₁₀-alcohol (isodecanol) and which are generally obtainable by hydrogenation of hydroformylated trimeric propene.

Copolymers according to the invention can exhibit several kinds of monomer units (ii), e.g. carboxylic acid esters with different carboxylic acids and/or different alkoxylate parts. According to a particular embodiment, the monomer units (ii) present in the copolymer derive from a carboxylic acid and in particular one of the carboxylic acids described above as preferred. Copolymers with monomer units (ii) essentially composed of monomer units of acrylic acid esters and in particular methacrylic acid esters have accordingly proved to be particularly suitable.

Accordingly, the copolymers include in particular monomer units (ii) of the formula (VIIb1) and/or of the formula (VIIb2) 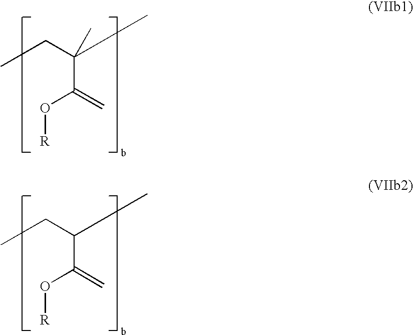
in which
R is one of the alkoxylate residues described above; and
b can be alike or different and is the mean number of the monomer units of the formula (VIIb1) or (VIIb2) in the polymer and corresponds preferably to a number ranging from 1 to 100, advantageously ranging from 5 to 50 and in particular ranging from 11 to 25.

In formula (VIIb1) or (VIIb2), R is advantageously an alkoxylate residue of the formula (I) and in particular of the formula (Ia).

In principle, all copolymerizable ethylenically unsaturated comonomers with at least one double bond, in particular monoethylenically unsaturated comonomers, are suitable as monomer units (iii).

Mention may in particular be made, for example, of salts, esters and amides of acrylic acid or methacrylic acid. The salts can be derived from any nontoxic metal, ammonium or substituted ammonium counterion, e.g. cations mentioned above under M.

The esters can—if not already employed as monomer unit (ii)—be derived from linear C₁-C₄₀, branched C₃-C₄₀ or carbocyclic C₃-C₄₀ alcohols, from polyfunctional alcohols with 2 to approximately 8 hydroxyl groups, such as ethylene glycol, hexylene glycol, glycerol and 1,2,6-hexanetriol, from aminoalcohols or from alcohol ethers, such as methoxyethanol and ethoxyethanol.

The amides can be unsubstituted, N-alkyl-substituted or N-alkylamino-monosubstituted or N,N-dialkyl-substituted or N,N-dialkylamino-disubstituted, in which the alkyl or alkylamino groups are derived from linear C₁-C₄₀, branched C₃-C₄₀ or carbocyclic C₃-C₄₀ units. The alkylamino groups can furthermore be quaternized.

Salts, esters and amides of substituted acrylic acids, in which the substituents are present on the carbon atoms in position 2 or 3 of the acrylic acid and are chosen, independently of one another, from C₁-C₄-alkyl, —CN and COOH, are comonomers which can likewise be used as monomer units (iii). Mention may particularly preferably be made here of salts, esters and amides of methacrylic acid, ethacrylic acid and 3-cyanoacrylic acid.

Particularly preferred as component (iii) are comonomers of the general formula (II):
Y—C(O)CR⁵═CHR⁶ (II)
in which
Y is chosen from —OM, —OR⁷, —NH₂, —NHR⁷ or —N(R⁷)₂, in which the R⁷ residues can be identical or different and are chosen from hydrogen, linear or branched C₁-C₄₀-alkyl, N,N-dimethylaminoethyl, 2-hydroxyethyl, 2-methoxyethyl, 2-ethoxyethyl, hydroxypropyl, methoxypropyl and ethoxypropyl, in which OR⁷ should not be OH;
M is a cation selected from alkali metal, alkaline earth metal and transition metal cations, in particular Na⁺, K⁺, Mg⁺⁺, Ca⁺⁺ and Zn⁺⁺, NH₄⁺ and quaternary ammonium cations, in particular alkylammonium, dialkylammonium, trialkylammonium and tetraalkylammonium; and
R⁵, R⁶ independently of one another, are chosen from hydrogen, linear or branched C₁-C₈-alkyl, methoxy, ethoxy, 2-hydroxyethoxy, 2-methoxyethoxy and 2-ethoxyethyl.

Furthermore, N,N-dialkylaminoalkyl acrylates and N,N-dialkylaminoalkyl methacrylates, along with N,N-dialkylamino-alkylacrylamides and N,N-dialkylaminoalkylmethacrylamides, of the general formula (III)
R¹¹R¹²N—R¹⁰-Z(R⁹)_{g}—C(O)CR⁸═CH₂ (III)
in which
R⁸ is hydrogen or C₁-C₈-alkyl;
R⁹ is hydrogen or methyl;
R¹⁰ is C₁-C₂₄-alkylene which can be substituted by alkyl;
R¹¹, R¹² independently of one another, are C₁₋₄₀-alkyl;
Z is nitrogen and g=1 or Z is oxygen and g=0;
   are suitable.

Preferred comonomers of the formula (III) are N,N-dimethylaminomethyl(meth)acrylate, N,N-diethylaminomethyl(meth)acrylate, N,N-dimethylaminoethyl(meth)acrylate, N,N-diethylaminoethyl (meth)acrylate, N-[3-(dimethylamino)-propyl]methacrylamide and N-[3-(dimethylamino)propyl]acrylamide. It should be mentioned at this point that the expression “(meth)acrylate” represents both “acrylate” and “methacrylate”.

Furthermore, allyl esters of linear C₁-C₄₀, branched C₃-C₄₀ or carbocyclic C₃-C₄₀ carboxylic acids, vinyl halides or allyl halides, preferably vinyl chloride and allyl chloride, vinylformamide, vinylmethylacetamide, vinylamine; vinyl- or allyl-substituted heterocyclic compounds, preferably vinylpyridine, vinyloxazoline and allylpyridine, are also suitable.

N-Vinylimidazoles of the general formula (IV) 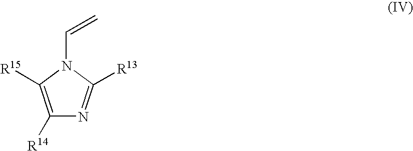
in which
R¹³-R¹⁵ independently of one another, are hydrogen, C₁-C₄-alkyl or phenyl,
   are also suitable.

Diallylamines of the general formula (V) 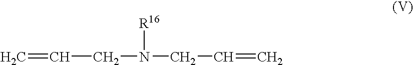
in which
R¹⁶ is C₁-C₂₄-alkyl,
   are likewise suitable.

Comonomers which can likewise be used as monomer units (iii) are olefins, i.e. in principle all unsaturated hydrocarbons with at least one ethylenically unsaturated polymerizable double bond. Olefins with a terminal double bond are advantageous. Monoethylenically unsaturated olefins are preferred. Monoethylenically unsaturated olefins with a terminal double bond are particularly preferred.

Preferred olefins have 4 to 40, in particular 4 to 24 and preferably 8 to 24 carbon atoms. According to a particular embodiment, the olefins have 8 to 24 or 18 to 24 or 20 to 24 carbon atoms.

Suitable olefins include, for example, but-1-ene, but-2-ene, butadiene, 2-methylprop-1-ene(isobutene), pent-1-ene, isoprene, 2-methylpent-1-ene, 3-methylpent-1-ene, 4-methylpent-1-ene, 2-ethylbut-1-ene, 4,4-dimethylbut-1-ene, 2,4-dimethylbut-1-ene, 2,3-dimethylpent-1-ene, 3,3-dimethylpent-1-ene, 2,4-dimethylpent-1-ene, 3,4-dimethylpent-1-ene, 4,4-dimethylpent-1-ene, oct-1-ene, 2,4,4-trimethylpent-1-ene, 2,4,4-trimethylpent-2-ene, diisobutene, in particular one which exists technically as an isomeric mixture of essentially 2,4,4-trimethylpent-1-ene and 2,4,4-trimethylpent-2-ene, e.g. in a ratio of approx. 80 weight % to approx. 20 weight %, 4,4-dimethylhex-1-ene, 2-ethylhex-1-ene, oligo- and polyisobutenes with a molecular weight of less than 2 000, oligopropenes with a molecular weight of less than 1 000, dec-1-ene, dodec-1-ene, tetradec-1-ene, hexadec-1-ene, heptadec-1-ene, octadec-1-ene, C₁₈-1-olefin, C₂₀-1-olefin, C₂₂-1-olefin, C₂₄-1-olefin, C₂₀- to C₂₄-1-olefin, C₂₄- to C₂₈-1-olefin, C₃₀-1-olefin, C₃₅-1-olefin, styrene, alkyl-substituted styrenes, such as α-methylstyrene, tert-butylstyrene or vinyltoluene, cyclic olefins, such as cyclooctene, and mixtures of these monomers.

Ethylene, propylene and vinylidene chloride are also suitable in principle as comonomers for the monomer units (iii).

Additional suitable monomer units (iii) are vinyl ethers, the alcohol part of which has 1 to 30 and preferably 1 to 20 carbon atoms. Mention may in particular be made here of C₁-C₃₀-alkyl vinyl ethers in which the alkyl residues can be linear, branched or cyclic and substituted or unsubstituted. Examples of suitable alkyl vinyl ethers are methyl vinyl ether, ethyl vinyl ether, propyl vinyl ether, isopropyl vinyl ether, butyl vinyl ether and dodecyl vinyl ether.

Comonomers for the monomer units (iii) which may in particular be mentioned are methyl acrylate, ethyl acrylate, propyl acrylate, n-butyl acrylate, isobutyl acrylate, t-butyl acrylate, 2-ethylhexyl acrylate, decyl acrylate, methyl methacrylate, ethyl methacrylate, propyl methacrylate, n-butyl methacrylate, isobutyl methacrylate, t-butyl methacrylate, 2-ethylhexyl methacrylate, decyl methacrylate, methyl ethacrylate, ethyl ethacrylate, n-butyl ethacrylate, isobutyl ethacrylate, t-butyl ethacrylate, 2-ethylhexyl ethacrylate, decyl ethacrylate, stearyl(meth)acrylate, 2,3-dihydroxypropyl acrylate, 2,3-dihydroxypropyl methacrylate, 2-hydroxyethyl acrylate, hydroxypropyl acrylate, 2-hydroxyethyl methacrylate, 2-hydroxyethyl ethacrylate, 2-methoxyethyl acrylate, 2-methoxyethyl methacrylate, 2-methoxyethyl ethacrylate, 2-ethoxyethyl methacrylate, 2-ethoxyethyl ethacrylate, hydroxypropyl methacrylate, glyceryl monoacrylate, glyceryl monomethacrylate and unsaturated sulfonic acids, such as, for example, acrylamidopropanesulfonic acid;

acrylamide, methacrylamide, ethacrylamide, N-methylacrylamide, N,N-dimethylacrylamide, N-ethylacrylamide, N-isopropylacrylamide, N-butylacrylamide, N-t-butylacrylamide, N-octylacrylamide, N-t-octylacrylamide, N-octadecylacrylamide, N-phenylacrylamide, N-methylmethacrylamide, N-ethylmethacrylamide, N-dodecylmethacrylamide, 1-vinylimidazole, 1-vinyl-2-methylvinylimidazole, N,N-dimethylaminomethyl(meth)acrylate, N,N-diethylaminomethyl(meth)acrylate, N,N-dimethylaminoethyl(meth)acrylate, N,N-diethylaminoethyl(meth)acrylate, N,N-dimethylaminobutyl(meth)acrylate, N,N-diethylaminobutyl(meth)acrylate, N,N-dimethylaminohexyl(meth)acrylate, N,N-dimethylaminooctyl(meth)acrylate, N,N-dimethylaminododecyl(meth)acrylate, N-[3-(dimethylamino)propyl]methacrylamide, N-[3-(dimethylamino)propyl]acrylamide, N-[3-(dimethylamino)butyl]methacrylamide, N-[8-(dimethylamino)octyl]methacrylamide, N-[12-(dimethylamino)dodecyl]methacrylamide, N-[3-(diethylamino)propyl]methacrylamide, N-[3-(diethylamino)propyl]acrylamide;

diallyldimethylammonium chloride, vinylformamide, vinylmethylacetamide, vinylamine; methyl vinyl ketone, vinylpyridine, vinylimidazole, vinylfuran, styrene, styrenesulfonate, allyl alcohol, and mixtures thereof.

Particularly preferred among these are methyl acrylate, methyl methacrylate, ethyl acrylate, ethyl methacrylate, n-butyl acrylate, n-butyl methacrylate, t-butyl acrylate, t-butyl methacrylate, isobutyl acrylate, isobutyl methacrylate, 2-ethylhexyl acrylate, stearyl acrylate, stearyl methacrylate, N-t-butylacrylamide, N-octylacrylamide, 2-hydroxyethyl acrylate, hydroxypropyl acrylate, 2-hydroxyethyl methacrylate, hydroxypropyl methacrylate, styrene, unsaturated sulfonic acids, such as, for example, acrylamidopropanesulfonic acid, vinylformamide, vinylmethylacetamide, vinylamine, 1-vinylimidazole, 1-vinyl-2-methylimidazole, N,N-dimethylaminomethyl methacrylate and N-[3-(dimethylamino)propyl]methacrylamide; 3-methyl-1-vinylimidazolium chloride, 3-methyl-1-vinylimidazolium methyl sulfate, N,N-dimethylaminoethyl methacrylate, N-[3-(dimethylamino)propyl]methacrylamide.

Comonomers or corresponding monomer units with a basic nitrogen atom can also be quaternized thereon in the following way:

Alkyl halides with 1 to 24 carbon atoms in the alkyl group, for example methyl chloride, methyl bromide, methyl iodide, ethyl chloride, ethyl bromide, propyl chloride, hexyl chloride, dodecyl chloride, lauryl chloride and benzyl halides, in particular benzyl chloride and benzyl bromide, are suitable, for example, for the quaternization of the amines. Additional suitable quaternizing agents are dialkyl sulfates, in particular dimethyl sulfate or diethyl sulfate. The basic amines can also be quaternized with alkylene oxides, such as ethylene oxide or propylene oxide, in the presence of acids. Preferred quaternizing agents are: methyl chloride, dimethyl sulfate or diethyl sulfate.

The quaternization can be carried out before or after the polymerization.

The reaction products of unsaturated acids, such as, e.g., acrylic acid or methacrylic acid, with a quaternary epichlorohydrin of the general formula (VI) 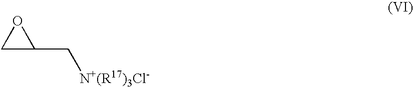
in which
R¹⁷ is C₁-C₄₀-alkyl,
   can furthermore be used.

Examples of such reaction products are
(meth)acryloyloxyhydroxypropyltrimethylammonium chloride and
(meth)acryloyloxyhydroxypropyltriethylammonium chloride.

The basic comonomers can also be cationized by being neutralized with inorganic acids, such as, e.g., sulfuric acid, hydrochloric acid, hydrobromic acid, hydriodic acid, phosphoric acid or nitric acid, or with organic acids, such as, e.g., formic acid, acetic acid, lactic acid or citric acid.

In addition to the abovementioned comonomers, “macromonomers”, such as, for example, silicone-comprising macromonomers with one or more groups capable of undergoing free radical polymerization or alkyloxazoline macromonomers, can be used for the monomer units (iii), such as are disclosed in EP 408 311. Reference is herewith expressly made to this publication and the macromonomers revealed therein.

In addition, fluorine-comprising monomers, such as are disclosed in EP 558 423, and compounds with a crosslinking activity or which regulate the molecular weight can be used, in combination or alone.

According to a particular embodiment, copolymers according to the invention comprise essentially no monomer units (iii). These copolymers accordingly are composed essentially of monomer units (i) and (ii). The proportion of monomer units (i) preferably amounts to 10 mol % to 99 mol %, advantageously 40 mol % to 95 mol % and in particular 60 mol % to 90 mol % and the proportion of monomer units (ii) preferably amounts to 90 mol % to 1 mol %, advantageously 60 mol % to 5 mol % and in particular 40 mol % to 10 mol %.

According to an additional particular embodiment, copolymers according to the invention comprise monomer units (iii). These copolymers accordingly are composed essentially of monomer units (i), (ii) and (iii). In the context of this embodiment, the proportion of monomer units (i) amounts to 60 mol % to 99 mol %, advantageously 70 mol % to 95 mol % and in particular 85 mol % to 95 mol %, the proportion of monomer units (ii) amounts to 30 mol % to 1 mol %, advantageously 20 mol % to 3 mol % and in particular 15 mol % to 5 mol %, and the proportion of monomer units (iii) amounts to up to 10 mol %, advantageously up to 5 mol % and in particular up to 1 mol %.

In this connection, the fact should be borne in mind that, at relatively low molecular weights, a deviation from the given values can occur due to an increase in the number of specific end monomer units.

As a rule, the copolymers to be used according to the invention exhibit a relatively small contact angle. Copolymers with a contact angle of less than 90° and preferably of less than 75°, determined in a way known per se using an aqueous solution comprising 2 weight % of copolymer on a paraffin surface, are particularly preferred.

The surface-active properties of the copolymers depend in particular on the kind and distribution of the monomer units. The surface tension of copolymers to be used according to the invention, which can be determined by the pendant drop method, preferably ranges from 20 to 72 mN/m, in particular 30 to 65 mN/m, for a solution comprising 0.1 to 2.0 weight % of copolymer. Copolymers preferably to be used according to the invention hence qualify as amphiphilic substances.

The weight-average molecular weight of the copolymerizates according to the invention lies between 5 000 and 800 000, preferably between 7 500 and 600 000, particularly preferably between 10 000 and 400 000.

The copolymers according to the invention are preferably not crosslinked.

The polymerizates according to the invention can be prepared by copolymerization of suitable monomers corresponding to the monomer units (i) and (ii) (monomers of the groups (i) or (ii)) and, if appropriate, of additional comonomers corresponding to the monomer units (iii) (comonomers of the group (iii)). To this end, the monomers or comonomers can be polymerized with the help of free-radical initiators or else by the action of high-energy radiation, which should be understood as also including the action of high-energy electrons (cf., e.g., EP 9 169 A1, EP 9 170 A1 and EP 276 464, which are expressly referred to).

The conventional peroxo and/or azo compounds used as initiators for free radical polymerization can be used, for example alkali metal or ammonium peroxydisulfates, diacetyl peroxide, dibenzoyl peroxide, succinyl peroxide, di(tert-butyl)peroxide, tert-butyl perbenzoate, tert-butyl perpivalate, tert-butyl permaleinate, cumene hydroperoxide, diisopropyl peroxydicarbamate, bis(o-toluoyl)peroxide, didecanoyl peroxide, dioctanoyl peroxide, dilauroyl peroxide, tert-butyl perisobutyrate, tert-butyl peracetate, di(tert-amyl)peroxide, tert-butyl hydroperoxide, azobisisobutyronitrile, azobis(2-amidonopropane)dihydrochloride or 2,2′-azobis(2-methylbutyronitrile). Initiator mixtures or redox/initiator systems, such as, e.g., ascorbic acid/iron(II)sulfate/sodium peroxodisulfate, tert-butyl hydroperoxide/sodium disulfite or tert-butyl hydroperoxide/sodium hydroxymethanesulfinate, are also suitable. Organic peroxides are preferably used.

The amounts of initiator or initiator mixtures used, based on the amounts of monomer used, lie between 0.01 and 10 weight %, preferably between 0.05 and 5 weight %.

As a rule, the polymerization is carried out in a temperature range from 40 to 200° C., preferably in the range from 50 to 140° C., particularly preferably in the range from 60 to 130° C. It is usually carried out at atmospheric pressure but can also proceed under reduced or elevated pressure, in the latter case preferably between 1 and 5 bar.

The polymerization can be carried out, for example, as solution polymerization, bulk polymerization, emulsion polymerization, inverse emulsion polymerization, suspension polymerization, inverse suspension polymerization or precipitation polymerization, without the methods which can be used being limited thereto.

In bulk polymerization, it is possible to proceed such that the monomers of the group (i), the monomers of the group (ii) and, if appropriate, additional comonomers of the group (iii) are mixed with one another and, after addition of a polymerization initiator, the mixture is fully polymerized. The polymerization can also be carried out semibatchwise by first introducing a portion, e.g. 10%, of the mixture of monomers or comonomers of the groups (i) and (ii) and, if appropriate, (iii) to be polymerized and initiator, by heating the mixture to polymerization temperature and, after the polymerization has started, by adding the remainder of the mixture to be polymerized according to the progress of the polymerization. The polymerizates can also be obtained by introducing the monomers of the group (i) into a reactor, heating to polymerization temperature, adding at least one monomer of the group (ii) and, if appropriate, one or more further comonomers of the group (iii) and polymerization initiator, either all at once, stepwise or, preferably, continuously, and polymerizing. The polymerization can in the process be carried out with the assistance of protective colloids, as disclosed, for example, in DT 2840201.

If desired, the abovedescribed polymerization can also be carried out in a solvent. Suitable solvents are, for example, alcohols, such as methanol, ethanol, n-propanol, isopropanol, n-butanol, sec-butanol, tert-butanol, n-hexanol and cyclohexanol, and glycols, such as ethylene glycol, propylene glycol and butylene glycol, and the methyl or ethyl ethers of dihydric alcohols, diethylene glycol, triethylene glycol, glycerol and dioxane. When using ethylenically unsaturated carboxylic acid esters from group (ii), it is preferable to use solvents which are inert with respect to the carboxylic acid esters used.

The polymerization can also be carried out in water as solvent. In this case, the polymerization mixture is first present as a solution which is more or less soluble in water depending on the amount of the monomers of the groups (i) and (ii) added and of the additional comonomers of the group (iii) added. In order to dissolve water-insoluble products which may be formed during the polymerization, it is possible to add, for example, organic solvents such as monohydric alcohols with 1 to 3 carbon atoms, acetone or dimethylformamide. However, it is also possible in the polymerization in water to proceed in such a way that the water-insoluble polymerizates are converted to a finely divided dispersion by addition of conventional emulsifiers or protective colloids, e.g. polyvinyl alcohol.

Examples of emulsifiers which are used are ionic or nonionic surfactants with HLBs ranging from 3 to 13. Reference is made to the publication by W. C. Griffin, J. Soc. Cosmetic Chem., Volume 5, 249 (1954), for the definition of the HLB.

The amount of surfactants, based on the polymerizate, generally amounts to 0.1 to 10 weight %. When water is used as solvent, solutions or dispersions of the polymerizates are obtained. If solutions of the polymerizate in an organic solvent or in mixtures of an organic solvent and water are prepared, 5 to 2 000, preferably 10 to 500, parts by weight of the organic solvent or of the solvent mixture are generally used per 100 parts by weight of the polymerizate.

The copolymers which can be used according to the invention can be obtained in particular by copolymerization
(1) of at least one vinylamide,
(2) of at least one ethylenically unsaturated carboxylic acid and/or of at least one ethylenically unsaturated carboxylic acid derivative, in particular a carboxylic acid ester, and, if appropriate,
(3) of at least one additional copolymerizable comonomer,
   and, if required, partial or complete solvolysis and/or derivatization, in particular esterification or transesterification, of the carboxylic acids and/or carboxylic acid derivatives.

In particular, the copolymer CP′ resulting from the copolymerization can, if necessary, be subjected to one or more of the following additional process steps:
(4) an at least partial solvolysis of derivatized carboxylic acid groups;
(5) an esterification of carboxylic acid groups;
(6) an at least partial neutralization of carboxylic acid groups.

The relative amounts of monomers and comonomers to be chosen for the purpose of the copolymerization can be inferred from the above remarks on the proportions of monomer units (i) and (ii) and, if appropriate, (iii).

The polymerization of monomers and comonomers which leads directly to the desired copolymer CP is preferred according to the invention.

The kind of monomers or comonomers to be used does not, though, depend only on the monomer units to be formed. Rather, it is in many cases advisable to polymerize monomers or comonomers which, subsequent to the polymerization reaction, are converted to the desired monomer units. This course of procedure may be conditioned by the reaction and process technology.

In particular, the monomers which can be used for the monomer units (ii) can differ from the monomer units involved in the formation of the copolymer CP. Thus, carboxylic acids or specific carboxylic acid derivatives can be polymerized first. The monomer units (ii′) thus formed, of the copolymer CP′, are subsequently as a rule subjected to one or more of the process steps (4), (5) and/or (6) described above, finally resulting in the copolymer CP or a salt thereof. In this sense, it is also possible to polymerize carboxylic acid esters with short-chain, readily hydrolyzable ester groups, such as alkyl esters with preferably 1 to 3 carbon atoms in the alkyl part, their alcohol part subsequently being split off and replaced with another alcohol.

The copolymer CP′ obtainable by copolymerization can accordingly comprise carboxyl groups and/or derivatized carboxyl groups, e.g. ester groups, which are subsequently, if desired, converted in a polymer-analogous reaction, generally with formation of the carboxylic acid esters. Preferred polymer-analogous reactions are (4) solvolyses, such as hydrolyses and alcoholyses, of carboxylic acid derivatives, and (5) esterifications of carboxyl groups.

According to one embodiment, copolymers CP to be used according to the invention can be obtained by (ii) choosing at least one ethylenically unsaturated carboxylic acid and copolymerizing it with the usual monomers or comonomers, and by reacting at least a portion of the carboxyl groups of the resulting copolymerization product CP′ with suitable alcohols with formation of esters.

The polymer-analogous reaction subsequent to the polymerization can be carried out in the presence of a solvent, for example acetone or tetrahydrofuran. However, it is preferable for the copolymer CP′ to be reacted directly with the derivatizing agent, e.g. an alcohol corresponding to the abovementioned formula (I). The amount of reactants to be employed depends on the degree of derivatization to be achieved.

If the derivatization is an esterification reaction, this is carried out in the usual way, viz. generally at elevated temperature, e.g. 50 to 200° C. and preferably at 80 to 150° C., if appropriate in the presence of a conventional catalyst, e.g. p-toluenesulfonic acid. Normal reaction times range from 0.5 to 20 and in particular 1 to 10 hours. The reaction of anhydride groups present in the polymer is preferred. This can be carried out, if appropriate, without solvent or in a solvent. If a solvent is used, those organic fluids which are inert to anhydride groups and which dissolve or swell not only the starting material but also the reaction product, viz. the at least partially esterified copolymer, are particularly suitable. Mention may be made in this connection of toluene, xylene, ethylbenzene, aliphatic hydrocarbons and ketones, such as acetone or methyl ethyl ketone. After the esterification, the solvent, if present, is removed from the reaction mixture, for example by distillation.

In order to form salts, the polymerizates can, before or after polymerization, be partially or completely neutralized with bases in order thus, for example, to adjust the water solubility or water dispersibility to a desired extent.

Use may be made, as neutralizing agents for acid groups, of, for example, inorganic bases, such as sodium carbonate, alkali metal hydroxides, such as sodium hydroxide or potassium hydroxide, alkaline earth metal hydroxides and ammonia, or organic bases, such as alkylamines, dialkylamines, trialkylamines, aminoalcohols, especially isopropylamine, ethylamine, diisopropylamine, diethylamine, triisopropylamine, triethylamine, 2-amino-2-methyl-1-propanol, monoethanolamine, diethanolamine, triethanolamine, triisopropanolamine, tri(2-hydroxy-1-propyl)amine, 2-amino-2-methyl-1,3-propanediol or 2-amino-2-hydroxymethyl-1,3-propanediol, and diamines, such as, for example, lysine.

The copolymers according to the invention based on N-vinylamide exhibit adjuvant, in particular action-promoting, properties in the treatment of plants. Thus, the addition of such copolymers makes possible an accelerated uptake of active compounds by a plant to be treated with the active compound. The adjuvant action results in particular in the following aspects in the treatment of plants with one or more active compounds:
in comparison, higher activity of the active compound for a given amount expended;
in comparison, smaller amount expended for a given effect;
in comparison, stronger uptake of the active compound by the plant, in particular via the leaf, and accordingly advantages postemergence, in particular in the spray treatment of plants.

The present invention accordingly also relates to the use of the copolymers as adjuvant in the treatment of plants.

The use according to the invention is aimed in particular at plant cultivation, agriculture and horticulture. It is used in particular for the control of undesired plant growth.

Accordingly, the present invention also relates to methods for the treatment of plants corresponding to the above purposes, in which a suitable amount of copolymer according to the invention is administered.

Particular advantages are achieved in particular in the cultivation of Allium cepa, Ananas comosus, Arachis hypogaea, Asparagus officinalis, Beta vulgaris spec. altissima, Beta vulgaris spec. rapa, Brassica napus var. napus, Brassica napus var. napobrassica, Brassica rapa var. silvestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pisum sativum, Prunus avium, Prunus persica, Pyrus communis, Ribes sylvestre, Ricinus communis, Saccharum officinarum, Secale cereale, Solanum tuberosum, Sorghum bicolor (s. vulgare), Theobroma cacao, Trifolium pratense, Triticum aestivum, Triticum durum, Vicia faba, Vitis vinifera and Zea mays.

In addition, the copolymers according to the invention can also be used in crops which tolerate the action of herbicides. Such crops can, for example, be obtained by breeding and also genetic engineering methods.

In accordance with the use in the agrotechnical field and especially in the field of plant protection, the copolymers can be used as stand-alone products and can be coadministered together with at least one composition comprising an active compound, they can be mixed, shortly before use, with at least one composition comprising an active compound and can be administered as corresponding mixture, or they can be incorporated as coformulant in the formulation as a ready mix.

The present invention accordingly also relates to compositions including
(a) at least one active compound for the treatment of plants; and
(b) at least one of the abovedescribed copolymers based on N-vinylamide.

Contributions of the component (b) to the total weight of the composition of more than 0.5 weight %, preferably of more than 1 weight % and in particular of more than 5 weight % are advantageous. On the other hand, contributions of the component (b) to the total weight of the composition of less than 50 weight %, preferably of less than 25 weight % and in particular of less than 10 weight % are generally advisable.

The active compound (component (a)) can be chosen from herbicides, fungicides, insecticides, acaricides, nematocides and active compounds which regulate plant growth.

Herbicidal plant protection compositions can comprise one or more, for example, of the following herbicidal plant protection active compounds:

1,3,4-thiadiazoles, such as buthidazole and cyprazole, amides, such as allidochlor, benzoylprop-ethyl, bromobutide, chlorthiamide, dimepiperate, dimethenamide, diphenamide, etobenzanid, flamprop-methyl, fosamine, isoxaben, monalide, naptalam, pronamide or propanil, aminophosphoric acids, such as bilanafos, buminafos, glufosinate-ammonium, glyphosate or sulfosate, aminotriazoles, such as amitrole, anilides, such as anilofos or mefenacet, aryloxyalkanoic acids, such as 2,4-D, 2,4-DB, clomeprop, dichlorprop, dichlorprop-P, fenoprop, fluroxypyr, MCPA, MCPB, mecoprop, mecoprop-P, napropamide, naproanilide or triclopyr, benzoic acids, such as chloramben or dicamba, benzothiadiazinones, such as bentazone, bleachers, such as clomazone, diflufenican, fluorochloridone, flupoxam, fluridone, pyrazolate or sulcotrione, carbamates, such as carbetamide, chlorbufam, chlorpropham, desmedipham, phenmedipham or vernolate, quinolinecarboxylic acids, such as quinclorac or quinmerac, dichloropropionic acids, such as dalapon, dihydrobenzofurans, such as ethofumesate, dihydrofuran-3-ones, such as flurtamone, dinitroanilines, such as benefin, butralin, dinitramine, ethalfluralin, fluchloralin, isopropalin, nitralin, oryzalin, pendimethalin, prodiamine, profluralin or trifluralin, dinitrophenols, such as bromofenoxim, dinoseb, dinoseb acetate, dinoterb, DNOC or dinoterb acetate, diphenyl ethers, such as acifluorfen-sodium, aclonifen, bifenox, chlornitrofen, difenoxuron, ethoxyfen, fluorodifen, fluoroglycofen-ethyl, fomesafen, furyloxyfen, lactofen, nitrofen, nitrofluorfen or oxyfluorfen, dipyridyls, such as cyperquat, difenzoquat metilsulfate, diquat or paraquat dichloride, imidazoles, such as isocarbamide, imidazolinones, such as imazamethapyr, imazapyr, imazaquin, imazamethabenz-methyl or imazethapyr, oxadiazoles, such as methazole, oxadiargyl or oxadiazone, oxiranes, such as tridiphane, phenols, such as bromoxynil or ioxynil, phenoxyphenoxypropionic acid esters, such as clodinafop, cyhalofop-butyl, diclofop-methyl, fenoxaprop-ethyl, fenoxaprop-P-ethyl, fenthiaprop-ethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl or quizalofop-P-tefuryl, phenylacetic acids, such as chlorfenac, phenylpropionic acids, such as chlorophenprop-methyl, ppi-active compounds, such as benzofenap, flumiclorac-pentyl, flumioxazin, flumipropyn, flupropacil, pyrazoxyfen, sulfentrazone or thidiazimin, pyrazoles, such as nipyraclofen, pyridazines, such as chloridazon, maleic hydrazide, norflurazone or pyridate, pyridinecarboxylic acids, such as clopyralid, dithiopyr, picloram or thiazopyr, pyrimidyl ethers, such as pyrithiobac acid, pyrithiobac-sodium, KIH-2023 or KIH-6127, sulfonamides, such as flumetsulam or metosulam, triazolecarboxamides, such as triazofenamide, uracils, such as bromacil, lenacil or terbacil, and furthermore benazolin, benfuresate, bensulide, benzofluor, butamifos, cafenstrole, chlorthal-dimethyl, cinmethylin, dichlobenil, endothal, fluorbentranil, mefluidide, perfluidone or piperophos.

Preferred herbicidal plant protection active compounds are those of the sulfonylurea type, such as amidosulfuron, azimsulfuron, bensulfuron-methyl, chlorimuron-ethyl, chlorsulfuron, cinosulfuron, cyclosulfamuron, ethametsulfuron-methyl, flazasulfuron, halosulfuron-methyl, imazosulfuron, metsulfuron-methyl, nicosulfuron, primisulfuron, prosulfuron, pyrazosulfuron-ethyl, rimsulfuron, sulfometuron-methyl, thifensulfuron-methyl, triasulfuron, tribenuron-methyl, triflusulfuron-methyl or tritosulfuron.

Further preferred herbicidal plant protection active compounds are those of the cyclohexenone type, such as alloxydim, clethodim, cloproxydim, cycloxydim, sethoxydim and tralkoxydim.

Very particularly preferred herbicidal active compounds of the cyclohexenone type are: tepraloxydim (cf. AGROW, No. 243, 3.11.95, page 21, caloxydim) and 2-(1-[2-{4-chlorophenoxy}-propyloxyimino]butyl)-3-hydroxy-5-(2H-tetrahydrothiopyran-3-yl)-2-cyclohexen-1-one, and of the sulfonylurea type: N-(((4-methoxy-6-[trifluoromethyl]-1,3,5-triazin-2-yl)amino)-carbonyl)-2-(trifluormethyl)-benzenesulfonamide.

The fungicidal compositions comprise one or more, for example, of the following fungicidal active compounds: sulfur, dithiocarbamates and their derivatives, such as ferric dimethyldithiocarbamate, zinc dimethyldithiocarbamate, zinc ethylenebisdithiocarbamate, manganese ethylenebisdithiocarbamate, manganese zinc ethylenediaminebisdithiocarbamate, tetramethylthiuram disulfide, ammonia complex of zinc (N,N′-ethylenebisdithiocarbamate), ammonia complex of zinc(N,N′-propylenebisdithiocarbamate), zinc(N,N′-propylenebisdithiocarbamate) or N,N′-polypropylenebis(thiocarbamoyl)disulfide;

nitro derivatives, such as dinitro(1-methylheptyl)phenyl crotonate, 2-sec-butyl-4,6-dinitrophenyl 3,3-dimethylacrylate, 2-sec-butyl-4,6-dinitrophenyl isopropyl carbonate or diisopropyl 5-nitroisophthalate;

heterocyclic substances, such as 2-heptadecyl-2-imidazoline acetate, 2,4-dichloro-6-(o-chloroanilino)-s-triazine, O,O-diethyl phthalimidophosphonothioate, 5-amino-1-[bis(dimethylamino)-phosphinyl]-3-phenyl-1,2,4-triazole, 2,3-dicyano-1,4-dithioanthraquinone, 2-thio-1,3-dithiolo[4,5-b]quinoxaline, methyl 1-(butylcarbamoyl)-2-benzimidazolecarbamate, 2-(methoxycarbonylamino)benzimidazole, 2-(2-furyl)benzimidazole, 2-(4-thiazolyl)benzimidazole, N-(1,1,2,2-tetrachloroethylthio)-tetrahydrophthalimide, N-(trichloromethylthio)-tetrahydrophthalimide, N-(trichloromethylthio)phthalimide,

N-dichlorofluoromethylthio-N′,N′-dimethyl-N-phenylsulfonyl-diamine, 5-ethoxy-3-trichloromethyl-1,2,3-thiadiazole, 2-thiocyanato-methylthiobenzothiazole, 1,4-dichloro-2,5-dimethoxybenzene, 4-(2-chlorophenylhydrazono)-3-methyl-5-isoxazolone, pyridine-2-thiol 1-oxide, 8-hydroxyquinoline or its copper salt, 2,3-dihydro-5-carboxanilido-6-methyl-1,4-oxathiin, 2,3-dihydro-5-carboxanilido-6-methyl-1,4-oxathiin 4,4-dioxide, 2-methyl-5,6-dihydro-4H-pyran-3-carboxanilide, 2-methylfuran-3-carboxanilide, 2,5-dimethylfuran-3-carboxanilide, 2,4,5-trimethylfuran-3-carboxanilide, N-cyclohexyl-2,5-dimethylfuran-3-carboxamide, N-cyclohexyl-N-methoxy-2,5-dimethylfuran-3-carboxamide, 2-methylbenzanilide, 2-iodobenzanilide, N-formyl-N-morpholine-2,2,2-trichloroethyl acetal, piperazine-1,4-diylbis(1-(2,2,2-trichloroethyl)formamide), 1-(3,4-dichloroanilino)-1-formylamino-2,2,2-trichloroethane, 2,6-dimethyl-N-tridecylmorpholine or its salts, 2,6-dimethyl-N-cyclododecylmorpholine or its salts, N-[3-(p-(tert-butyl)phenyl)-2-methylpropyl]-cis-2,6-dimethyl-morpholine, N-[3-(p-(tert-butyl)phenyl)-2-methylpropyl]-piperidine, 1-[2-(2,4-dichlorophenyl)-4-ethyl-1,3-dioxolan-2-ylethyl]-1H-1,2,4-triazole, 1-[2-(2,4-dichlorophenyl)-4-(n-propyl)-1,3-dioxolan-2-ylethyl]-1H-1,2,4-triazole, N-(n-propyl)-N-(2,4,6-trichlorophenoxyethyl)-N′-imidazolylurea,
1-(4-chlorophenoxy)-3,3-dimethyl-1-(1H-1,2,4-triazol-1-yl)-2-butanone,
1-(4-chlorophenoxy)-3,3-dimethyl-1-(1H-1,2,4-triazol-1-yl)-2-butanol,
(2RS,3RS)-1-[3-(2-chlorophenyl)-2-(4-fluorophenyl)oxiran-2-ylmethyl]-1H-1,2,4-triazole,
α-(2-chlorophenyl)-α-(4-chlorophenyl)-5-pyrimidinemethanol,
5-butyl-2-dimethylamino-4-hydroxy-6-methylpyrimidine,
bis(p-chlorophenyl)-3-pyridinemethanol, 1,2-bis(3-ethoxycarbonyl-2-thioureido)benzene or
1,2-bis(3-methoxycarbonyl-2-thioureido)benzene,

strobilurins, such as methyl
E-methoxyimino-α-(o-tolyloxy-o-tolyl)acetate, methyl E-2-{2-[6-(2-cyanophenoxy)pyrimidin-4-yloxy]phenyl}-3-methoxyacrylate,
methyl-E-methoxyimino-α-(2-phenoxyphenyl)acetamide or
methyl-E-methoxyimino-α-(2,5-dimethylphenoxy-o-tolyl)acetamide,

anilinopyrimidines, such as
N-(4,6-dimethylpyrimidin-2-yl)aniline,
N-[4-methyl-6-(1-propynyl)pyrimidin-2-yl]aniline or
N-[4-methyl-6-cyclopropylpyrimidin-2-yl]aniline,

phenylpyrroles, such as
4-(2,2-difluoro-1,3-benzodioxol-4-yl)pyrrole-3-carbonitrile,

cinnamamides, such as
3-(4-chlorophenyl)-3-(3,4-dimethoxyphenyl)acryloylmorpholine,

and various fungicides, such as dodecylguanidine acetate,
3-[3-(3,5-dimethyl-2-oxycyclohexyl)-2-hydroxyethyl]glutarimide, hexachlorobenzene, methyl
N-(2,6-dimethylphenyl)-N-(2-furoyl)-DL-alaninate,
N-(2,6-dimethylphenyl)-N-(2′-methoxyacetyl)-DL-alanine methyl ester,
N-(2,6-dimethylphenyl)-N-chloroacetyl-D,L-2-aminobutyrolactone,
N-(2,6-dimethylphenyl)-N-(phenylacetyl)-DL-alanine methyl ester,
5-methyl-5-vinyl-3-(3,5-dichlorophenyl)-2,4-dioxo-1,3-oxazolidine,
3-[3,5-dichlorophenyl(-5-methyl-5-methoxymethyl]-1,3-oxazolidine-2,4-dione,
3-(3,5-dichlorophenyl)-1-isopropylcarbamoylhydantoin,
N-(3,5-dichlorophenyl)-1,2-dimethylcyclopropane-1,2-dicarboximide,
2-cyano-[N-(ethylaminocarbonyl)-2-methoxyimino]acetamide,
1-[2-(2,4-dichlorophenyl)pentyl]-1H-1,2,4-triazole,
2,4-difluoro-α-(1H-1,2,4-triazol-1-ylmethyl)benzhydryl alcohol,
N-(3-chloro-2,6-dinitro-4-(trifluoromethyl)phenyl)-5-trifluoromethyl-3-chloro-2-aminopyridine or
1-((bis(4-fluorophenyl)methylsilyl)methyl)-1H-1,2,4-triazole.

Useful growth regulators are, e.g., the group of the gibberellins. These include, e.g., the gibberellins GA₁, GA₃, GA₄, GA₅ and GA₇, and the like, and the corresponding exo-16,17-dihydrogibberellins, and the derivatives thereof, e.g. the esters with C₁-C₄ carboxylic acids. The exo-16,17-dihydro-GA₅ 13-acetate is preferred according to the invention.

According to one embodiment of the present invention, the active compound component (a) is composed essentially of one or more of the following preferred active compounds: bentazone, difenzoquat, pendimethalin, quinclorac, cycloxydim, quinmerac, sethoxydim, cinidon-ethyl, mecoprop, mecoprop-P, dichlorprop, chloridazon, dicamba, metobromuron, profoxydim, tritosulfuron, diflufenzopyr, S-dimethenamide, cyanazine, picolinafen, cyclosulfamuron, imazamethabenz-methyl, imazaquin, acifluorfen, nicosulfuron, sulfur, dithianon, tridemorph, metiram, nitrothal-isopropyl, thiophanate-methyl, metholachlor, triforine, carbendazim, vinclozolin, dodine, fenpropimorph, epoxiconazole, cresoxim-methyl, pyraclostrobin, dimoxystrobin, cyazofamid, fenoxanil, dimethomorph, metconazole, dimethoate, chlorfenvinphos, phorate, fenbutatin oxide, chlorfenapyr, simazine, bensulfuron, flufenoxuron, teflubenzuron, alphacypermethrin, cypermethrin, hydramethylnon, terbufos, temephos, halofenozide, flocoumafen, triazamate, flucythrinate, hexythiazox, dazomet, chlorocholine chloride, mepiquat chloride or prohexadione-Ca, or of one or more of the following particularly preferred active compounds: epoxiconazole, pyraclostrobin, metazachlor, paraquat, glyphosate, imazethapyr, tepraloxydim, imazapic, imazamox, acetochlor, atrazine, tebufenpyrad, trifluralin or pyridaben.

The adjuvant effect of the copolymers according to the invention makes itself felt particularly advantageously with active compounds from the class of the strobilurins, e.g. with pyraclostrobin, and active compounds from the class of the triazoles, e.g. with metconazole, tebuconazole, triadimenol, triadimefon, cyproconazole, uniconazole, paclobutrazol or ipconazole and in particular epoxiconazole.

The present invention relates in particular to compositions with high proportions of active compound (concentrates). Thus, the proportion of the component (a) generally makes up more than 10 weight %, preferably more than 15 weight % and in particular more than 20 weight % of the total weight of the composition. On the other hand, the proportion of the component (a) is advisably generally less than 80 weight %, preferably less than 70 weight % and in particular less than 60 weight % of the total weight of the composition.

The formulations according to the invention can incidentally comprise conventional auxiliaries and/or additives for the preparation of formulations in the agrotechnical field and in particular in the area of plant protection. These include, for example, surfactants, dispersants, wetting agents, thickeners, organic solvents, cosolvents, antifoaming agents, carboxylic acids, preservatives, stabilizers, and the like.

In accordance with a particular embodiment of the present invention, the compositions include, as surface-active component (c), at least one (additional) surfactant. The term “surfactant” in this context denotes surface-active agents.

The component (c) is added in particular as dispersant or emulsifier, especially in order to disperse a solid component in suspension concentrates. Furthermore, parts of the component (c) can be used as wetting agent.

Anionic, cationic, amphoteric and nonionic surfactants can be used in principle, including polymer surfactants and surfactants with heteroatoms in the hydrophobic group.

The anionic surfactants include, for example, carboxylates, in particular alkali metal, alkaline earth metal and ammonium salts of fatty acids, e.g. potassium stearate, which are usually also referred to as soaps; acylglutamates; sarcosinates, e.g. sodium lauroylsarcosinate; taurates; methylcelluloses; alkyl phosphates, in particular alkyl esters of monophosphoric acid and diphosphoric acid; sulfates, in particular alkyl sulfates and alkyl ether sulfates; sulfonates, further alkylsulfonates and alkylarylsulfonates, in particular alkali metal, alkaline earth metal and ammonium salts of arylsulfonic acids and alkyl-substituted arylsulfonic acids, alkylbenzenesulfonic acids, such as, for example, lignosulfonic acid and phenolsulfonic acid, naphthalenesulfonic acids and dibutylnaphthalenesulfonic acids, or dodecylbenzenesulfonates, alkylnaphthalenesulfonates, alkyl methyl ester sulfonates, condensation products of sulfonated naphthalene and derivatives thereof with formaldehyde, condensation products of naphthalenesulfonic acids, lignitic and/or phenolsulfonic acids with formaldehyde or with formaldehyde and urea, mono or dialkyl sulfosuccinates; and protein hydrolysates and lignin sulfite waste liquors. The abovementioned sulfonic acids are advantageously used in the form of their neutral or, if appropriate, basic salts.

The cationic surfactants include, for example, quaternary ammonium compounds, in particular alkyltrimethylammonium halides, dialkyldimethylammonium halides, alkyltrimethylammonium alkyl sulfates and dialkyldimethylammonium alkyl sulfates, and pyridine and imidazoline derivatives, in particular alkylpyridinium halides.

The nonionic surfactants include, for example, other alkoxylates and especially ethoxylates, in particular
fatty alcohol polyoxyethylene esters, for example lauryl alcohol polyoxyethylene ether acetate,
alkyl polyoxyethylene ethers and alkyl polyoxypropylene ethers, e.g. of linear fatty alcohols, and alkylaryl alcohol polyoxyethylene ethers, e.g. octylphenol polyoxyethylene ether,
alkoxylated animal and/or vegetable fats and/or oils, for example corn oil ethoxylates, castor oil ethoxylates or tallow fat ethoxylates,
glycerol esters, such as, for example, glycerol monostearate,
fatty alcohol alkoxylates and oxo alcohol alkoxylates, in particular of the linear type R₅O—(R₃O)ᵣ(R₄O)ₛR₂₀ with R₃ and R₄, independently of one another, ═C₂H₄, C₃H₆ or C₄H₈ and R₂₀═H or C₁-C₁₂-alkyl, R₅═C₃-C₃₀-alkyl or C₆-C₃₀-alkenyl, and r and s, independently of one another, 0 to 50, it not being possible for both to be 0, such as oleyl alcohol polyoxyethylene ether,
alkylphenol alkoxylates, such as, for example, ethoxylated isooctylphenol, octylphenol or nonylphenol, tributylphenol polyoxyethylene ether,
fatty amine alkoxylates, fatty acid amide alkoxylates and fatty acid diethanolamide alkoxylates, in particular their ethoxylates,
sugar surfactants, sorbitol esters, such as, for example, sorbitan fatty acid esters (sorbitan monooleate, sorbitan tristearate) or polyoxyethylene sorbitan fatty acid esters, alkylpolyglycosides or N-alkylgluconamides,
alkyl methyl sulfoxides,
alkyldimethylphosphine oxides, such as, for example, tetradecyldimethylphosphine oxide.

The amphoteric surfactants include, for example, sulfobetaines, carboxybetaines and alkyldimethylamine oxides, e.g. tetradecyldimethylamine oxide.

The polymeric surfactants include, for example, di-, tri- and multiblock polymers of the (AB)ₓ, ABA and BAB types, e.g. optionally end-group-capped ethylene oxide/propylene oxide block copolymers, e.g. ethylenediamine-EO/PO-block copolymers, polystyrene-block-polyethylene oxide, and AB comb polymers, e.g. polymethacrylate-comb-polyethylene oxide.

Other surfactants which should be mentioned in this context by way of example are perfluorinated surfactants, silicone surfactants, e.g. polyether-modified siloxanes, phospholipids, such as, for example, lecithin or chemically modified lecithins, amino acid surfactants, e.g. N-lauroylglutamate, and surface-active homo- and copolymers, e.g. polyacrylic acids in the form of their salts, polyvinyl alcohol, polypropylene oxide, polyethylene oxide, maleic anhydride/isobutene copolymers and vinylpyrrolidone/vinyl acetate copolymers.

If not specified, the alkyl chains of the surfactants listed above are linear or branched residues with usually 8 to 20 carbon atoms.

The additional surfactant in the context of the component (c) is advantageously chosen from nonionic surfactants. The nonionic surfactants with an HLB ranging from 2 to 16, preferably ranging from 5 to 16 and in particular ranging from 8 to 16 are particularly preferred.

The proportion of component (c), if present, generally amounts to less than 50 weight %, preferably less than 15 weight % and in particular less than 5 weight % of the total weight of the composition.

According to a particular embodiment of the present invention, the compositions include, as component (d), at least one additional auxiliary.

The component (d) can serve many different purposes. The choice of suitable auxiliaries is made in the usual way by a person skilled in the art according to the requirements.

Additional auxiliaries are chosen, for example, from
(d1) solvents or diluents;
(d2) emulsifiers, retention agents, pH buffers or antifoaming agents.

In addition to water, the compositions can include additional solvents of soluble constituents or diluents of insoluble constituents of the composition.

Examples which can be used in principle are mineral oils, synthetic oils, vegetable oils and animal oils, and low-molecular-weight hydrophilic solvents, such as alcohols, ethers, ketones and the like.

On the one hand, therefore, mention may be made of aprotic or nonpolar solvents or diluents, such as mineral oil fractions of medium to high boiling point, e.g. kerosene and diesel oil, further coal-tar oils, hydrocarbons, liquid paraffins, e.g. C₈- to C₃₀-hydrocarbons of the n-alkane or isoalkane series or mixtures thereof, optionally hydrogenated or partially hydrogenated aromatics or alkylaromatics from the benzene or naphthalene series, e.g. aromatic or cycloaliphatic C₇- to C₁₈-hydrocarbon compounds, aliphatic or aromatic carboxylic acid esters or dicarboxylic acid esters, or fats or oils of vegetable or animal origin, such as mono-, di- and triglycerides, in the pure form or as a mixture, for example in the form of oily extracts of natural products, e.g. olive oil, soybean oil, sunflower oil, castor oil, sesame oil, corn oil, groundnut oil, rapeseed oil, linseed oil, almond oil, castor oil or safflower oil, and their raffinates, e.g. hydrogenated or partially hydrogenated products thereof and/or their esters, in particular methyl and ethyl esters.

Examples of C₈- to C₃₀-hydrocarbons of the n-alkane or isoalkane series are n-octane, n-decane, n-hexadecane, n-octadecane, n-icosane, isooctane, isodecane, isohexadecane, isooctadecane and isoicosane, and preferably hydrocarbon mixtures, such as liquid paraffin (the technical grade of which can comprise up to approximately 5% aromatics) and a C₁₈-C₂₄ mixture which is commercially available from Texaco under the description Spraytex oil.

The aromatic or cycloaliphatic C₇- to C₁₈-hydrocarbon compounds include in particular aromatic or cycloaliphatic solvents from the alkylaromatics series. These compounds can be nonhydrogenated, partially hydrogenated or completely hydrogenated. Such solvents include in particular mono-, di- or trialkylbenzenes, mono-, di- or trialkyl-substituted tetralins and/or mono-, di-, tri- or tetraalkyl-substituted naphthalenes (alkyl is preferably C₁-C₆-alkyl). Examples of such solvents are toluene, o-, m- or p-xylene, ethylbenzene, isopropylbenzene, tert-butylbenzene and mixtures, such as the products from Exxon sold under the names Shellsol and Solvesso, e.g. Solvesso 100, 150 and 200.

Examples of suitable monocarboxylic acid esters are oleic acid esters, in particular methyl oleate and ethyl oleate, lauric acid esters, in paticular 2-ethylhexyl laurate, octyl laurate and isopropyl laurate, isopropyl myristate, palmitic acid esters, in particular 2-ethylhexyl palmitate and isopropyl palmitate, stearic acid esters, in particular n-butyl stearate, and 2-ethylhexyl 2-ethylhexanoate.

Examples of suitable dicarboxylic acid esters are adipic acid esters, in particular dimethyl adipate, di(n-butyl) adipate, di(n-octyl) adipate, diisooctyl adipate, also denoted by bis(2-ethylhexyl) adipate, di(n-nonyl) adipate, diisononyl adipate and ditridecyl adipate; succinic acid esters, in particular di(n-octyl) succinate and diisooctyl succinate, and diisononyl cyclohexane-1,2-dicarboxylate.

The proportion of the abovedescribed aprotic solvents or diluents generally amounts to less than 80 weight %, preferably less than 50 weight % and in particular less than 30 weight % of the total weight of the composition.

Some of these aprotic solvents or diluents can likewise have adjuvant, i.e. in particular action-promoting, properties. This applies in particular to said monocarboxylic acid esters and dicarboxylic acid esters. From this viewpoint, such adjuvants can also be mixed with the copolymers according to the invention or compositions comprising them at an expedient point in time, generally shortly before administration, as part of another formulation (stand-alone product).

On the other hand, mention may be made of protic or polar solvents or diluents, e.g. C₂-C₈ monoalcohols, such as ethanol, propanol, isopropanol, butanol, isobutanol, tert-butanol, cyclohexanol and 2-ethylhexanol, C₃-C₈ ketones, such as diethyl ketone, t-butyl methyl ketone and cyclohexanone, and aprotic amines, such as N-methylpyrrolidone and N-octylpyrrolidone.

The proportion of the abovedescribed protic or polar solvents or diluents generally amounts to less than 80 weight %, preferably less than 50 weight % and in particular less than 30 weight % of the total weight of the composition.

Sedimentation inhibitors can also be used, in particular for suspension concentrates. They are used in particular for rheological stabilization. Mention may in particular be made in this connection of mineral products, e.g. bentonites, talcites and hectorites.

Other additives which can be used, if appropriate, are to be found, e.g., among inorganic salt solutions, which are used to rectify nutritional and trace element deficiencies, nonphytotoxic oils and oil concentrates, antidrift reagents, antifoaming agents, in particular those of the silicone type, for example the Silicon SL sold by Wacker, and the like.

The formulations can be provided in the form of an emulsifiable concentrate (EC), a suspoemulsion (SE), an oil-in-water emulsion (O/W), a water-in-oil emulsion (W/O), an aqueous suspension concentrate, an oil suspension concentrate (SC), a microemulsion (ME), and the like.

The compositions can be prepared in a way known per se. For this, at least some of the components are mixed together. It should be taken into consideration, in this connection, that products, in particular standard products, can be used, the constituents of which can contribute to different components. For example, a specific surfactant can be dissolved in an aprotic solvent so that this product can contribute to different components. Furthermore, small proportions of less desired substances may also possibly be introduced with standard products. The products which have been combined to form a mixture can then generally be intensively mixed with one another to form a homogeneous mixture and, if necessary, e.g. in the case of suspensions, can be milled.

The mixing can be carried out in a way known per se, e.g. by homogenizing with suitable devices, such as KPG or magnetic stirrers.

The milling is also a process known per se. The milling elements which can be used are glass milling elements or other inorganic or metallic milling elements, generally with a size of 0.1-30 mm and in particular of 0.6-2 mm. The mixture is generally comminuted until the desired particle size has been achieved.

In general, the milling can be carried out using a circulating operation, i.e. continuous recirculation, for example of an SC, in the circuit, or using a passage operation, i.e. one in which a batch is completely and repeatedly pumped through or passed through.

The milling can be carried out with conventional ball, bead or stirrer mills, e.g. in a Dynomühle (Bachofen), with batch sizes of, for example, 0.5 up to 1 liter in a “passage operation”. After several, in particular 4 to 6, passes (the slurry is pumped through the mill using a peristaltic pump), mean particle sizes, by microscopic evaluation, of 0.5 to 10 μm are thereby achieved.

The compositions are converted before use, generally by diluting in the usual way, to a form which can be used for the application. It is preferable to dilute with water or else aprotic solvents, for example in the tank mix method. Use in the form of a spray emulsion preparation is preferred. The administration can be by the preemergence or postemergence procedure. There are particular advantages to the postemergence procedure.

The use according to the invention also includes the employment of the copolymers according to the invention based on N-vinylamide as stand-alone product. For this, the copolymers based on N-vinylamide are prepared in a suitable way in order to be added, shortly before the application, to the composition to be administered.

Above all, there are particular advantages to the spray treatment. For a conventional tank mix spray emulsion, the compositions according to the invention, already comprising at least one copolymer based on N-vinylamide, or other plant treatment compositions with addition of at least one copolymer based on N-vinylamide as stand-alone product are diluted with water in such a way that approximately 0.01 to 10, preferably approximately 0.05 to 5 and in particular 0.1 to 1 kg of at least one copolymer according to the invention are administered per ha.

In the context of the present description, the term “alkyl” embraces straight-chain or branched hydrocarbon groups, such as methyl, ethyl, n-propyl, isopropyl, n-butyl, isobutyl, sec-butyl, t-butyl, n-pentyl, n-hexyl, n-octyl, 2-ethylhexyl, n-nonyl, isononyl, n-decyl, isodecyl, n-undecyl, isoundecyl, n-dodecyl, isododecyl, n-tridecyl, isotridecyl, stearyl or n-icosyl, preferably, unless otherwise specified, with 1 to 8, in particular 1 to 6 and particularly preferably 1 to 4 carbon atoms for short-chain residues and 5 to 30, in particular 12 to 24 and particularly preferably 8 to 20 carbon atoms for long-chain residues. The branched long-chain residues include in particular 2-ethylhexyl, isononyl, isodecyl, such as 2-propylheptyl, isoundecyl, isododecyl and isotridecyl, such as 2,4,6,8-tetramethyl-1-nonyl, 3,4,6,8-tetramethyl-1-nonyl and 5-ethyl-4,7-dimethyl-1-nonyl.

In the context of the present description, amounts generally refer to the total weight of a composition, unless otherwise specified. The expression “essentially” generally denotes according to the invention a percentage of at least 80%, preferably of at least 90% and in particular of at least 95%.

The invention is explained in greater detail using the following examples:

### PREPARATION EXAMPLES

### Reference Examples 1 and 2

Preparation of the Copolymers (a) and (b)

### Reference Example 1

Vinylpyrrolidone/Lutensol AT25MA copolymer 95/5

A solution of 342 g of N-vinylpyrrolidone and 18 g of Lutensol-AT-25 methacrylate (C₁₆/C₁₈ fatty alcohol ethoxylate with 25 EO units) in 750 g of isopropanol is heated to 75° C. under an inert atmosphere. A solution of 0.9 g of 2,2′-azobis(2-methyl-butyronitrile) (WAKO V59) in 50 g of isopropanol is added to the reaction mixture over 4 hours. The mixture is then heated to 85° C. and 0.9 g of 2,2′-azobis(2-methylbutyronitrile) (WAKO V59) in 40 g of isopropanol is added all at once. The reaction mixture is stirred for a further 2 hours. On conclusion of the polymerization, the isopropanol is distilled off and 840 g of water are added in the meantime. A cloudy solution of a copolymer is obtained, the copolymer comprising 95 weight % of monomer units (i) and 5 weight % of monomer units (ii).

### Reference Example 2

Vinylpyrrolidone/Lutensol AT25MA Copolymer 85/15

A solution of 306 g of vinylpyrrolidone and 54 g of Lutensol-AT-25 methacrylate (C₁₆/C₁₈ fatty alcohol ethoxylate with 25 EO units) in 750 g of isopropanol is heated to 75° C. under an inert atmosphere. A solution of 0.9 g of 2,2′-azobis(2-methyl-butyronitrile) (WAKO V59) in 50 g of isopropanol is added to the reaction mixture over 4 hours. The mixture is then heated to 85° C. and 0.9 g of 2,2′-azobis(2-methylbutyronitrile) (WAKO V59) in 40 g of isopropanol is added all at once. The reaction mixture is stirred for a further 2 hours. On conclusion of the polymerization, the isopropanol is distilled off and 840 g of water are added in the meantime. A cloudy solution of a copolymer is obtained, the copolymer comprising 85 weight % of monomer units (i) and 15 weight % of monomer units (ii).

### Example 1

### Biological Activity

Improvement in the Fungicidal Activity

Both of the leaves which developed first of wheat seeds of the variety “Kanzler”, which were raised in pots, were dusted with spores of Puccinia recondita. In order to guarantee the success of the artificial inoculation, the plants were kept for 24 hours in a humidity chamber without light at a relative humidity of 95 to 99% and a temperature of 20 to 22° C. The next day, the plants were sprayed with an aqueous suspension comprising fungicide at the concentration given below as a mixture with water and 125 ppm of the test additive. The plants were allowed to dry in the air. The experimental plants were subsequently cultivated in a greenhouse for 8 days at a temperature of 22 to 26° C. and a relative humidity of between 40 and 80%. The extent of the fungal infestation on the leaves was assessed visually and expressed as a percentage of the affected leaf area with respect to the unaffected leaf area. The results for the fungicides pyraclostrobin and epoxiconazole are given in the following table:

TABLE

| | % affected leaf area | | |
|---|---|---|---|
| Concentration of | Test additive | | |
| the fungicide | | Copolymer from | Copolymer from |
| (ppm a.c.) | — | example 1 | example 2 |
| Pyraclostrobin ¹) | | | |
| 2 | 13 | 5 | 7 |
| 1 | 32 | 25 | 17 |
| Epoxiconazole ²) | | | |
| 0.25 | 47 | 22 | 25 |
| 0.125 | 53 | 53 | 47 |

¹) 65% affected leaf area with untreated plants
²) 83% affected leaf area with untreated plants

It is clearly apparent that the copolymers according to the invention in the sense of an adjuvant significantly strengthen the fungicidal action of pyraclostrobin or epoxiconazole.

1-13. (canceled)

14. A composition comprising
(a) at least one active compound for the treatment of plants; and
(b) at least one N-vinylamide-based copolymer, wherein the copolymer comprises monomer units
(i) of at least one N-vinylamide,
(ii) of at least one ester of an ethylenically unsaturated carboxylic acid, and, optionally,
(iii) of at least one additional copolymerizable comonomer, wherein the carboxylic acid ester exhibits alkoxylate residues of the general formula (I)
(R¹)ₙ—X—(CHR²CH₂O)_{w}—(CHR³CH₂O)ₓ—(CHR⁴(CH₂)_{y}O)_{z}— (I),
in which
R¹ is hydrogen or an aliphatic hydrocarbon residue with 3 to 40 carbon atoms;
R², R³, R⁴ are, independently of one another, hydrogen or C₁-₄-alkyl;
w, x, z correspond, independently of one another, to a value of 0 to 100, the sum of w, x and z being greater than 0;
y corresponds to a value of 1 to 20;
X is N or O,
n being 1 and R¹ not being hydrogen if X is O; or n being 2 if X is N.

15. A composition as claimed in claim 14, wherein the N-vinylamide is chosen from N-vinylpyrrolidone and N-vinylcaprolactam.

16. A composition as claimed in claim 14, wherein the ethylenically unsaturated carboxylic acid is acrylic acid or methacrylic acid.

17. A composition as claimed in claim 14, wherein the carboxylic acid esters exhibit ethoxylate residues of the general formula (la)
R¹—O—(C₂H₄O)_{z}— (Ia)
in which
R¹ is branched or linear, saturated or unsaturated C₅-₁₅-alkyl; and
z corresponds to a value of 1 to 100.

18. A composition as claimed in claim 14, wherein the additional copolymerizable comonomer is chosen from (meth)acrylamide, (meth)acrylonitrile, alkyl(meth)acrylates and alkyl vinyl ethers.

19. A composition as claimed in claim 14, which comprises
(i) 99 to 60 weight % of monomer units (i);
(ii) 1 to 30 weight % of monomer units (ii); and
(iii) 0 to 10 weight % of monomer units (iii).

20. A method of treating plants which comprises applying the composition as claimed in claim 14 as adjuvant to the plants.

21. The method as claimed in claim 20 for improving the effectiveness of an active compound for plant protection.

22. The method as claimed in claim 20 in plant cultivation, in agriculture or in horticulture.

23. The method as claimed in claim 20 for controlling undesired plant growth.

24. The method as claimed in claim 20, wherein the treatment is postemergence treatment.

25. The method as claimed in claim 20, wherein the treatment is spray treatment of plants.

26. The method as claimed in claim 20, wherein the composition is applied as tank additive.

27. A method of treating plants which comprises applying the composition as claimed in claim 15 as adjuvant to the plants.

28. A method of treating plants which comprises applying the composition as claimed in claim 16 as adjuvant to the plants.

29. A method of treating plants which comprises applying the composition as claimed in claim 17 as adjuvant to the plants.

30. A method of treating plants which comprises applying the composition as claimed in claim 18 as adjuvant to the plants.

31. A method of treating plants which comprises applying the composition as claimed in claim 19 as adjuvant to the plants.
